(19) United States
(12) Patent Application Publication
(10) Pub. No.: US 2011/0071907 A1
(43) Pub. Date: Mar. 24, 2011

(54) Charitable organization implemented through an interactive social media networking community website

(76) Inventor: Lewis Scott Lewis, Bonita, CA (US)

(21) Appl. No.: 12/649,346

(22) Filed: Dec. 30, 2009

Related U.S. Application Data
(60) Provisional application No. 61/244,011, filed on Sep. 18, 2009.

(51) Int. Cl. G06Q 40/00; G06Q 30/00; G06Q 20/00; G06Q 99/00; G06F 3/01

(52) U.S. Cl. 705/14.69; 705/39; 705/319; 705/329; 715/751; 705/26.1

(57) ABSTRACT

A means and method of facilitating charitable contributions through an interactive social media networking community website with advertising, contribution, and distribution functions is disclosed. The current invention is designed to maximize charitable contributions and allow for a custom-tailored distribution scheme that more effectively raises and distributes charitable contributions that is offered by any of the currently available charities.

### CROSS REFERENCE TO RELATED APPLICATIONS

This application is a non-provisional of U.S. Provisional Patent Application No. 61/244,011 filed on Sep. 18, 2009, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

1. Field of the Invention

This invention relates to the general field of charitable organizations and methods of acquiring and distributing charitable contributions, and more specifically toward an organization implemented through an interactive social media networking community website with advertising, contribution, and distribution functions. The goal of the current invention is to maximize charitable contributions and allow for a custom-tailored distribution scheme that more effectively raises and distributes charitable contributions that is offered by any of the currently available charities.

2. History of the Relevant Industry

Charitable institutions have been in existence in various forms for thousands of years. In the 1800's, some of the larger charitable organizations, including the American Red Cross and United Way, were formed as a means of collecting charitable contributions and distributing these contributions to locations and people who needed help.

A major problem faced by all charitable organizations is how to maximize the amount of money donated to them. Particularly in rough economic times, the generally-accepted means of collecting contributions at least partially fail, and many programs relying upon regular injections of charitable capital either fail or become extremely limited in their functionality.

Another major problem with today's charitable organizations is that it is difficult to custom-tailor a charitable donation and giving program to specific needs, particularly when these needs are inconsistent in nature. For example, it is easy to predict that a certain inner city playground will need basketball nets replaced on a regular basis, but no one could have predicted that a tsunami would cause untold suffering through the Indian Ocean.

The prior art has several examples of attempts to resolve this, such as the charitable organizations well known in the United States and other countries, but none of these organizations has a recession-proof fundraising scheme combined with a custom-tailorable distribution scheme that evolves on a daily basis utilizing ongoing input from the contributors themselves.

Thus there has existed a long-felt need for a charitable organization and method of managing contributions and distributions that maximizes the contributions and effectively distributes charitable gifts in a manner that is efficient and flexible.

The current invention provides just such a solution by having an organization that increases membership and contributions through celebrity and non-celebrity endorsements, and distributes charitable contributions through an ever-changing and adaptive means.

### SUMMARY OF THE INVENTION

It is a principal object of the invention to maximize charitable contributions.

It is another object of the invention to engage celebrities, athletes, politicians and other publicity-seeking individuals to providing free advertising for a charitable organization.

It is an additional object of the invention that distribution of the charitable donations be flexible and adaptable to changing global situations.

It is a further object of the invention that individual contributors can play an active role in raising money for specific causes and have a voice in determining where their charitable contributions are sent.

It is also an object of this invention that charitable contributions can be obtained from a wide variety of individuals and companies, with a sliding scale of contributions versus publicity and public exposure.

It is a final object of this invention that participants at all levels will be drawn to the organization, and be enthusiastic about contributing to it and working with it because of the positive image it will project for them.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a flow chart showing the flow of money from the users, through the organization and to the various other associated charitable entities.

FIG. 2 is a flow chart of the interactions between the users and the organization.

FIG. 3 is a flow chart of one embodiment of the member distribution system that distributes money to charities.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

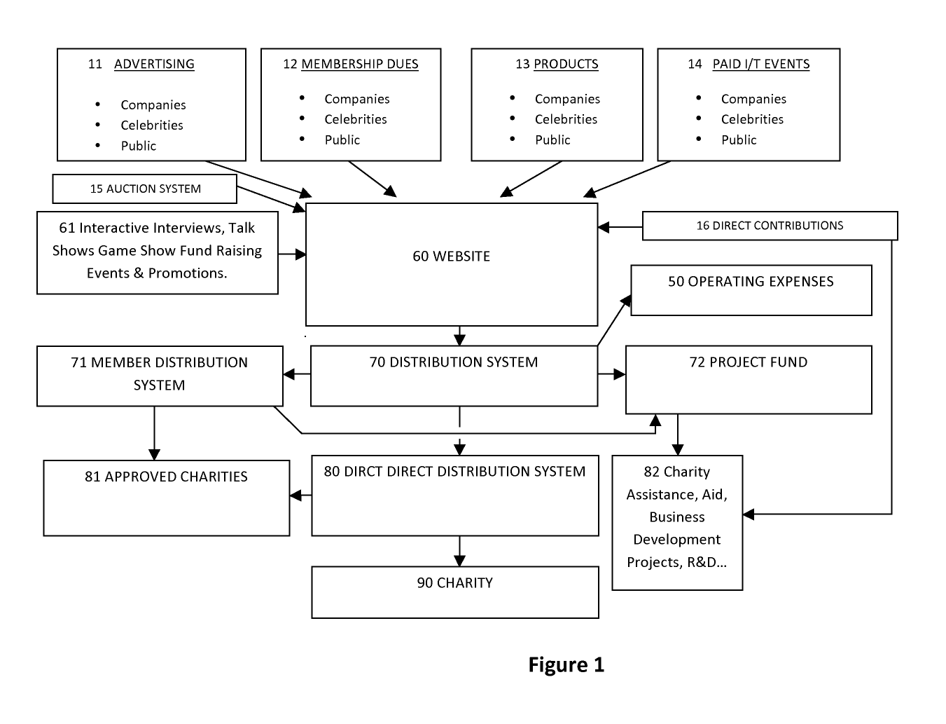

FIG. 1 is a flow chart showing the flow of money from the users, through the organization's website and to the various associated charitable entities. Various entities contribute money and other assets to the organization through its website 60.

Advertising 11 is possible on or through the website 60 to generate income to the organization. Companies, celebrities, and the public may purchase advertising 11 on and/or through the website 60. The organization may use Google®, Yahoo®, MSN®, and other similar advertising methods to generate income. The website can be monetized to earn income based upon the number of visitors and use of sponsored links. Companies, celebrities, and the public may directly purchase advertising space on the website in the form of links, banners, videos, and other web marketing techniques well known in the art.

Membership dues 12 are paid to the organization through the website 60. The amount paid by a member (membership dues) can be different based upon various membership options. Members can include companies, celebrities, public, or any other person or entity that would desire to pay money in exchange for the services provided by the organization. By way of example, possible membership levels can include Junior, Individual, Business, Corporate, and Alliance. Junior membership features adaptable programming for children ages 5 to 14 and is free of charge. Individual membership is a basic public membership that includes a blog and/or webpage, general membership privileges, the ability to compete for cash and prizes, and charitable assignment credits. Business membership includes the Individual membership features plus additional high-tech marketing tools, advertising and/or promotional credits, and access to private business communities. Corporate membership includes the Business membership features plus additional accounts, additional marketing tools, and a larger number of advertising and/or promotional credits. Alliance membership includes the Corporate membership features plus additional top-level promotional credits, possible business joint ventures, entitlements, and bonuses. Further each membership level can be further separate by “Plus” membership, for example Individual Plus or Business Plus membership, whereby additional privileges, credits, and/or other benefits are conferred without jumping to the next level of membership.

Members of the organization may purchase additional products 13 through the website. These products 13 can include website products with customized templates for personal and business use, internet marketing tools, software, and other services, organizational tools, e-business tools, subset club membership fees, and physical merchandize and services. The price for the products 13 can be the same for all members are can vary depending on the membership level of the user.

Members can host paid interactive and/or tangible events through the organization's website 60. While the event may be organized, paid for, and/or otherwise promoted through the website 60, the event itself may be live (in-person) or otherwise completed outside of the realm of the website 60. The organization hosts paid per attendance/viewing events to raise additional charitable contributions, awareness of the organization's mission, and increase overall revenue to the organization. For example, a star tennis player may host a public meet and teach session separate or in conjunction with the organization's fundraising even, where an entrance fee is charged to the general public and no fee or a discounted fee is charged to active members of the organization. As an additional example, a star golf player may volunteer to participate in an interactive online interview with members of the organization; non-members may view the interview by paying a one-time fee. Another example is where the organization regularly holds an event associated with a national sports league to raise additional charitable contributions, awareness of the organization's mission, and increase the organization's overall revenue.

Additional revenue may be generated for the organization through an auctions system 15. Auctions sell memorabilia, signature items, land, vehicles, art, jewelry, and other items and services to raise money and donate a portion of the proceeds to fund charitable entities associated with the organization. Non-members of the organization may place up for auction various items or services through the organization's auction house or in cooperation with another auction house approved by the organization. A minimum percentage of the auction sale must be committed prior to the auction taking place for the organization to approve the use of its name and reputation with the auction. Non-member use of the organization's auction is through the direct distribution system 80, discussed below. Members may place various items and services up for action in the same manner noted above, except that the donation assignments will take place using the member's existing account with the organization, as explained in further detail below. The organization itself coordinates with the approved auction house (or itself) to withhold proceeds upon completion of each sale. The auction will withhold an agreed upon percentage of the proceeds of each sale and release the proceeds to the organization to be deposited into a pre-established account for distribution through the direct distribution system 80.

Direct contributions 16 can also be made through the website 60. Members or non-members of the organization may make direct charitable contributions to the organization's charity 90 or approved charities through the direct distribution system 80.

The organization's website 60 connects members with charities through an interactive online experience. The website 60 hosts live or previously recorded, interactive micro fund raising internet marathons 365 days a year with celebrities and local leaders that the members want to see, hear from, and talk to the most. Celebrities and people from every walk of life rally to raise funds for their favorite charities directly. Members are allowed to assign donations to their favorite approved charitable entity at no additional cost to the members themselves. Niches covered may include every topic known to man. Initial niches include entertainment, politics, and humanitarian aid. Members select the charities and/or fund raising campaigns they want to donate to. The organization in turn, distributes the funds to the selected organizations in the honor of the member or, alternatively, the member may remain anonymous.

In addition to the interaction through the website 60, paid interactive/tangible events 14 allow members and celebrities to become contestants in game shows, appear together in talk shows, and other events that bring members closer to their favorite celebrities. Various participation activities and competitions are hosted by the organization on an ongoing basis allowing members to participate and win spots on these paid interactive/tangible events 14.

A personal social web page and/or blog with templates featuring the ability to monetize and market them can be provided to members, either for free or for a fee depending upon their level of membership. One or more free and/or paid email addresses can be provided for members using the organization's domain name, or a separate domain name. The personal social web page and/or blog and email address(es) can be managed through the website 60.

The organization's paid sponsors provide exclusive discount coupons and gifts to its members. As a reward for becoming a member, the organization supports mainly those sponsors that want to contribute products and services to improve the organization's members' lives as they continue to improve the lives of others. Further, music downloads donated by artists themselves to members may be promoted as fundraisers as well for sponsored charitable entities. Members may also receive discounted yearly subscriptions to print magazines. Celebrities volunteer to the organization and their own charities found within the organization's database.

Through the website 60, members may enter competitions or raffles to gain entrance to interactive events that take place online and offline. When a member is selected for the interactive event they competed for or chose, the organization automatically generates a donation in the member's honor and assigns it to the pre-selected charity/fundraiser of their choice. Members may win an opportunity to be part of a live interview session with one of their favorite celebrities that share common interests with them. Additionally, members may win an opportunity to interact with the celebrity live online. Members may view live, written (simulcast), audio or audio video promotions and assign donations, following the distribution system 70. Non-members may make a deposit and view the promotions noted above then donate using the direct distribution system 80. These approved promotional interviews may be promoted using any and all media platforms available, such as TV, radio, magazines, internet, and news papers.

The organization's distribution system 70 distributes funds obtained directly or indirectly through the website 60 and distributes these funds to the appropriate entity or system. The distribution system 70 allocates a portion of the income to the operating expenses 50 of the organization. Operating expenses include without limitation salaries, employee wages, and other expenses normally associated with an organization's operations.

A member distribution system 71 receives a portion of the income generated by the website 60 through the distribution system 70. Preferably, the distribution system 70 deposits a minimum of 2.5% of the revenue it receives into the member distribution system 71. Members of the organization are allotted a specific number of assignable donations based upon their membership level and the amount of money in the member distribution system. Members, through the website 60, can assign a number of donations to approved charities 81. Approved charities include without limitations, charitable organizations, aid foundations, fund raising, and other altruistic organizations that have been approved by the organization. Alternatively, members may assign a donation to the project fund 72, described below.

The distribution system 70 matches or exceeds the amount deposited into the member distribution system and deposits that amount into the project fund 72. The project fund 72 is a holding tank for funds that are to be distributed by the organization at its sole discretion. These funds typically are distributed in special programs 82 that the organization believes will improve the lives of the people the organization is attempting to serve. These funds can also be distributed to the organization's own charity 90, other approved charities 81, or to the member distribution system 71 for distribution by the members.

The special programs 82 can include aid to charitable entities, providing educational resources, creating outreach centers to support communities, providing college scholarships, funding research and development for solving national, global, and environmental challenges, purchasing and distributing food, medicine, and other aid to those in need, funding special events and fundraisers, and launching new businesses that result in new jobs and support local communities.

Direct contributions 16 made through the website 60 flow through the distribution system 70 and to the direct distribution system 80. Members and non-members of the organization make direct charitable donations to the approved charities 81 or the organization's own charity 90 through the direct distribution system 80.

While the organization itself may be a for-profit entity, the organization's own charity 90 is preferably a not for profit charity organized under 26 U.S.C. §501(c)(3). This will allow the organization as a whole to operate as a private, for-profit entity, if desired, while still enabling certain contributions to its own charity to be tax deductable.

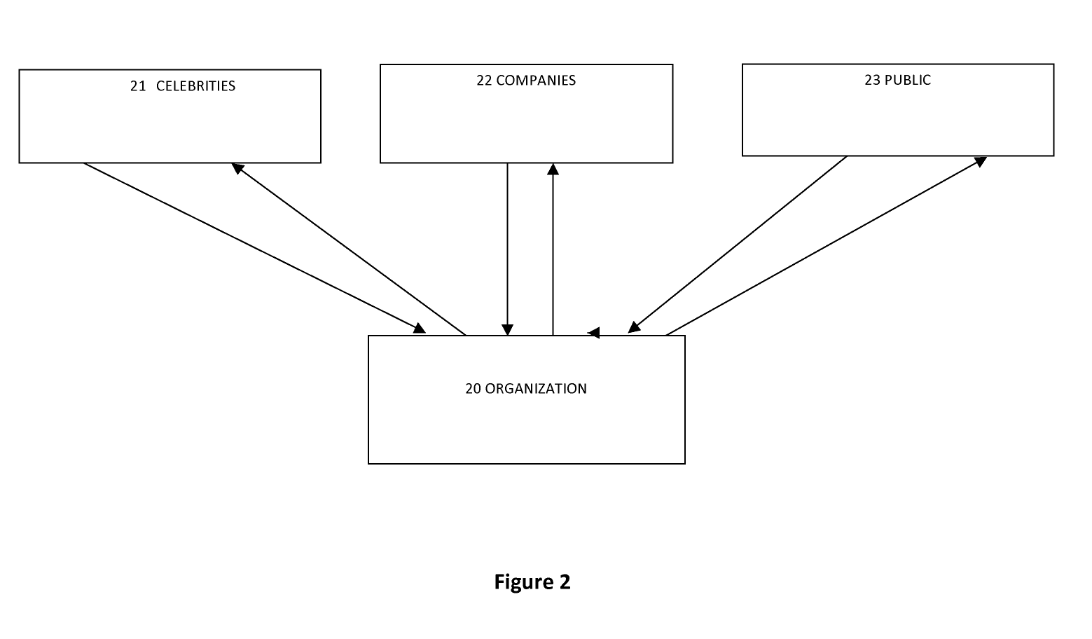

FIG. 2 is a flow chart of the interactions between members and the organization. Celebrities 21 can be members of the organization 20. Celebrities 21 include without limitation actors, athletes, sport professionals, musicians, politicians, performers, and other professionals renowned in their field of expertise. Celebrities 21 contribute time, money, products, and endorsements to the organization 20. In return, celebrities 21 receive promotion of charities or funds of their choice, promotional credits, and advertising.

Companies 22 include without limitation corporations, limited liability companies (LLCs), sole proprietors, partnerships, individuals, and other for-profit or not for-profit, private or public entities. Companies contribute time, money, products and/or services, and endorsements to the organization 20. In return, Companies receive promotional credits, advertising, compensation for services provided to or through the organization 20, and discounts on services provided by or through the organization 20.

Through the interactions on the website, members can view the endorsements and recommendations of others for different charities, products, services, and any other element where endorsements and recommendations are beneficial.

The public 23 can be members of the organization 20, and provide to the organization, money, time, and endorsements to the organization in exchange for their membership, donations to charitable organizations, access to the interactive website, products and/or services at a discount, and chances to win cash and/or prizes.

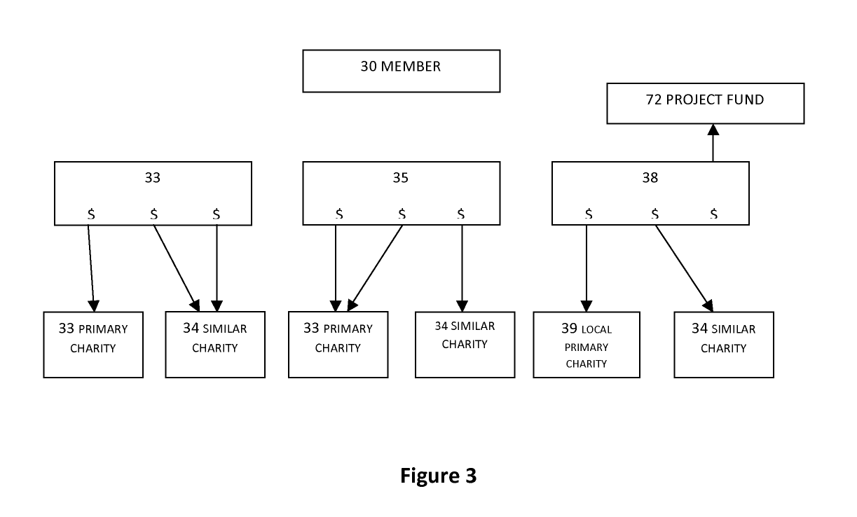

FIG. 3 is a flow chart of one embodiment of the member distribution system that distributes money to charities. Members 30 assign their charitable donations to specific charities or the project fund 72 through the member distribution system 71. Assignments are made by first choosing a specific charity or a charitable cause through the website 60. A similar charity can also be selected by the member, where a list of similar charities are displayed by the website 60. The member can then assign a donation to these charities. For example, member 32 assigns one donation unit to a primary charity 33 and two donation units to a similar charity 34. Member 35 assigns two donation units to a primary charity and one donation unit to a similar charity. Member 38 assigns one donation unit to a local primary charity 39, one unit to a similar charity 34, and one unit to the project fund 72. The charities made available to the user can be all available charities, a random list of charities, or particular charities provided by the system to maintain a more even distribution of charitable donations to the various charitable entities.

Throughout this process, appropriate tax documents will be issued by applicable charitable organizations. Transfers of funds can be mad in dollars, or converted to other units for ease of use. Then, at a later date, these units can be converted back into a monetary amount for distribution. The term “website” as used herein is intended to mean a user interface accessible via a browser over the Internet. “Online” as used herein is intended to mean interactions over the Internet. “Offline” as used herein is intended to mean interactions not over the Internet.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A means of facilitating charitable contributions through a website comprising
a website, a distribution system, a member distribution system, a direct distribution system, a project fund, an organization, and a plurality of members,
where the website is operated by the organization, where the members interact with each other and the organization through the website, where the members contribute assets to the organization through the website,
where the assets contributed to the organization through the website are distributed by the distribution system, where the distribution system allocates assets to pay for operating expenses of the organization, to the member distribution system, to the direct distribution system, and to the project fund, where the assets allocated to the project fund are at least as valuable as those allocated to the member distribution system,
where members select one or more entities to receive the assets allocated to the member distribution system, where the organization selects one or more entities to receive the assets allocated to the project fund,
where members or non-members can make contributions to one or more entities through the website using the direct distribution system.

2. The means of facilitating charitable contributions through a website of claim 1, wherein the members comprise one or more celebrities.

3. The means of facilitating charitable contributions through a website of claim 1, wherein the members comprise one or more companies.

4. The means of facilitating charitable contributions through a website of claim 1, wherein the assets comprise money.

5. The means of facilitating charitable contributions through a website of claim 1, wherein the assets comprise products and/or services.

6. The means of facilitating charitable contributions through a website of claim 1, wherein the members interact with each other and the organization through interactive interviews.

7. The means of facilitating charitable contributions through a website of claim 1, wherein the members interact with each other and the organization through a game show.

8. The means of facilitating charitable contributions through a website of claim 1, further comprising an auction system, where items and/or services are sold resulting in proceeds, where a percentage of the proceeds of each sale are allocated to one or more entities through the direct distribution system.

9. The means of facilitating charitable contributions through a website of claim 1, wherein the one or more entities are charities.

10. The means of facilitating charitable contributions through a website of claim 1, where the organization receives additional asset contributions in exchange for advertisements placed on the website.

11. A method of interacting through a website comprising the steps of
a) becoming a member of the website, where the website is operated by an organization,
b) transferring assets to the organization,
c) selecting a charity through the website,
d) having the organization make a donation on the member's behalf to the selected charity,
e) having the organization make a donation to another entity of the organization's choosing.

12. The method of claim 11, wherein the transfer of assets to the organization is payment of money through the website.

13. The method of claim 11, further comprising the step of interacting with other members through the website.

14. The method of claim 11, further comprising the step of making a direct contribution to a charity through the website.

15. The method of claim 11, further comprising the step of endorsing one or more charities.

16. The method of claim 11, wherein the transfer of assets to the organization is the provision of one or more services and/or products to one or more other members.

17. A method of interacting through a website comprising the steps of
a) becoming a member of the website, where the website is operated by an organization,
b) paying a membership fee to the organization through the website,
c) selecting a charity through the website,
d) having the organization make a donation on the member's behalf to the selected charity,
e) having the organization make a donation to another entity of the organization's choosing.

18. The method of claim 17, further comprising the step of creating a customized social networking webpage through the website.

19. The method of claim 17, further comprising the step of participating in one or more interactive interviews provided through the website.

20. The method of claim 17, further comprising the step of participating in one or more auctions provided through the website, where at least a portion of money paid through the one or more auctions is transferred to a charity.
